(19) United States
(12) Patent Application Publication
(10) Pub. No.: US 2011/0276513 A1
(43) Pub. Date: Nov. 10, 2011

(54) METHOD OF AUTOMATIC CUSTOMER SATISFACTION MONITORING THROUGH SOCIAL MEDIA

(75) Inventors: George Erhart, Loveland, CO (US); Valentine C. Matula, Granville, OH (US); David Skiba, Golden, CO (US)

(73) Assignee: AVAYA INC., Basking Ridge, NJ (US)

(21) Appl. No.: 12/777,031

(22) Filed: May 10, 2010

(51) Int. Cl. G06Q 99/00; G06F 17/30

(52) U.S. Cl. 705/347; 707/722; 707/E17.107; 707/705

(57) ABSTRACT

Methods and systems provided herein provide an enterprise with the ability to conduct automated customer feedback surveys. In particular, customer interactions on social media channels are intelligently monitored, aggregated, filtered, and analyzed to determine a customer's response to a particular product or service. Since customers are more likely to be truthful regarding their reaction to a product or service on a neutral forum, such as a social media channel, more accurate customer feedback can be obtained in a less intrusive manner than has previously been available.

### FIELD OF THE INVENTION

The present invention is generally directed toward customer surveys and is particularly directed toward mechanisms for automatically conducting customer surveys.

### BACKGROUND

Customer satisfaction is an important metric to successful businesses. Measuring customer satisfaction is a difficult and expensive task. Third party service companies are often used to perform follow-up surveys. Coupons campaigns are another option companies use to entice customers to fill out post-service surveys.

There are several problems with the existing methods of conducting customer surveys. These methods require extra cost and management time to the business. Additionally, the surveys are an artificial measure of satisfaction in that a natural customer response is generally not attainable through a template or form. As such, surveys may produce artificial or inaccurate responses. Moreover, existing survey methods also require the customer to do something extra, and many are not willing to do so.

The problem for a business is finding an effective and simple method of determining customer satisfaction without burdening the customer or utilizing valuable business resources.

### SUMMARY

It is with respect to the above issues and other problems that the embodiments presented herein were contemplated. Embodiments of the present invention propose a method of utilizing the increased use of social media and the ability to monitor social media interactions to produce a customer satisfaction metric without formal surveys or other artificial methods.

One aspect of the present invention is to provides a social media gateway. The gateway is responsible for gathering all social media interactions and bringing them into a contact center or similar analysis enterprise. This may be an internally developed gateway (i.e., with respect to the contact center) or a third-party product. In some embodiments, the gateway acquires the location information of a social media interaction, if available.

Another aspect of the present invention is to provide a survey tracker database. This database contains the information about transactions to be tracked. Included is the specification of location, keyword or other attribute of the service. For example, a flight from Chicago to Paris would have a location region for Paris as the starting monitor point. The database may also store information relating to the length of time for monitoring or conducting an automated survey.

Another aspect of the present invention is to provide a system manages any users known to an entity (e.g., existing customers to a business). Increasingly businesses are obtaining the social media identification of customers. If available, users are added to a database entry for all users of a particular service. A common exemplary occurrence would be to add the Twitter identifier of a user who recently purchased a Sony TV. Alternatively, or in addition, social media identifiers of all known users on a United flight from Chicago to Paris may be added into the service database.

In some embodiments, as service is completed, a monitoring task (i.e., an automated customer survey) is started whereby all social media interactions from any known users of the service, any posts from the specific location of the service, and/or anyone mentioning something related to the service is monitored and aggregated. This monitoring and aggregation may occur for a specified amount of time utilizing defined filter criteria. Embodiments of the present invention take advantage of casual interactions of the users. The monitoring time will be adjustable by the business based on past experience and the specific service.

The interactions are analyzed either as they come in to the contact center or after the monitoring expires (i.e., a bulk analysis on all gathered interactions). An analysis of the interactions allows the entries passing a first set of filter criteria to be classified, using existing text processing algorithms, to see if they specifically relate to the service offered. Existing text processing and natural language processing techniques are used to classify and attach satisfaction scores to each specific social media interaction. By processing during the specified service monitor time, the system will be able to give a real-time satisfaction score and track the evolution of that score over time. When the monitor time expires, the completed data will be processed and a final satisfaction result will be generated. This satisfaction result may be based on a single customer or a collection of customers who received a common service or product.

In some embodiments, the system will be able to generate and transmit automated responses to low score users or high score users over the same social media channels monitored. This provides a non-intrusive way for responding to either positive or negative customer feedback on a social media channel.

As one non-limiting example, a user contacts Dell for a service issue with a laptop product via chat. The Dell service representative guides the user through a diagnostic tree and determines that the laptop needs to be repaired. The Dell representative sets up an in-office service call, informs the caller of the details, etc. The next day, the service tech arrives at the customer office, repairs the laptop and leaves. Embodiments of the present invention create an observation task when the Dell Service representative opens the initial trouble ticket for the first call. Social media channels may then be monitored for posts by the end-user that are commenting on Dell and their service. In some embodiments, surveys may be bifurcated, one for the product and another for the service. This bifurcation may vary depending upon the content of the comments and the timing thereof. The monitoring process continues for a period of time after the service representative finishes the repair and closes the ticket. The accumulated comments are assessed for positive/negative sentiment. The assessed quality of service metric could be for the entire transaction or could be broken down into the contact with the service representative via the chat, or the service tech that actually does the repair, or both.

This allows a company to obtain, in real-time, customer feedback that is generally more honest than the type of feedback usually obtained in a formalistic customer survey. In particular, since the feedback is received from an information source where the customer is more likely to provide their true comments and feelings regarding the product or service, the feedback is more accurate and representative of the customer's true feelings. Moreover, by monitoring the feedback on a social media channel, embodiments of the present invention provide a quick and efficient mechanism for responding to negative feedback (e.g., damage control) or positive feedback.

In accordance with at least some embodiments of the present invention, a method is provided that generally comprises:

detecting a survey-initiating trigger;

based on the detecting step, identifying one or more publicly-available information sources;

monitoring the identified one or more publicly-available information sources for a predetermined amount of time after the detection of the survey-initiating trigger;

retrieving data from the one or more publicly-available information sources for the predetermined amount of time; and

generating survey results based on the retrieved data.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “stalking” means the process of determining a person is presently using a social media network and can be contacted on that social media network in real time.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

### BRIEF DESCRIPTION OF THE DRAWINGS

The present disclosure is described in conjunction with the appended figures:

FIG. 1 is a block diagram of an embodiment of a communication system operable to interact with persons using social media networks;

FIG. 2A is a block diagram of an embodiment of a social media gateway;

FIG. 2B is a block diagram of an embodiment of a dialog system;

FIG. 2C is a block diagram of an embodiment of a customer tracker;

FIG. 3 is a block diagram of an embodiment of a dialog data structure;

FIG. 4 is flow diagrams of an embodiment of a process for conducting an automated customer survey;

FIG. 5 is a block diagram of an embodiment of a computing environment; and

FIG. 6 is a block diagram of an embodiment of a computing system.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

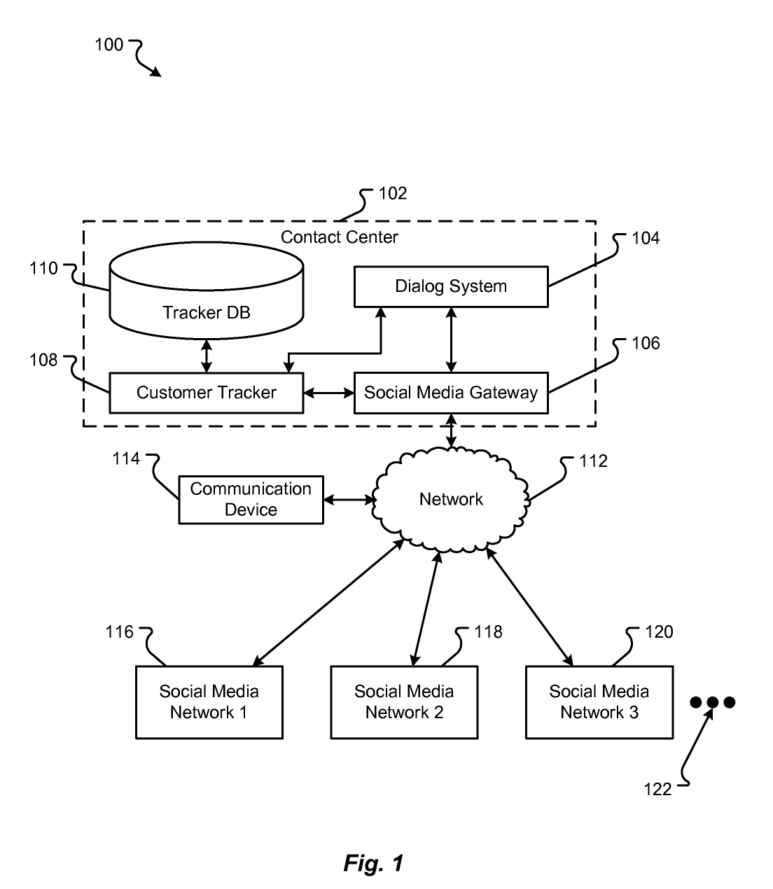

A communication system 100, for interacting with persons and conducting automated surveys using social media is shown in FIG. 1. The communication system 100 can include a contact center 102, a network 112, and one or more types of social media networks or systems, such as social media network 1 116, social media network 2 118, and social media network 3 120. Social media networks 1 116, 2 118, and/or 3 120 can be any social media including, but not limited to, networks, websites, or computer enabled systems. For example, a social media network may be MySpace, Facebook, Twitter, Linked-In, Spoke, or other similar computer enabled systems or websites. The communication system 100 can communicate with more or fewer social media networks 116, 118, and/or 120 than those shown FIG. 1, as represented by ellipses 122

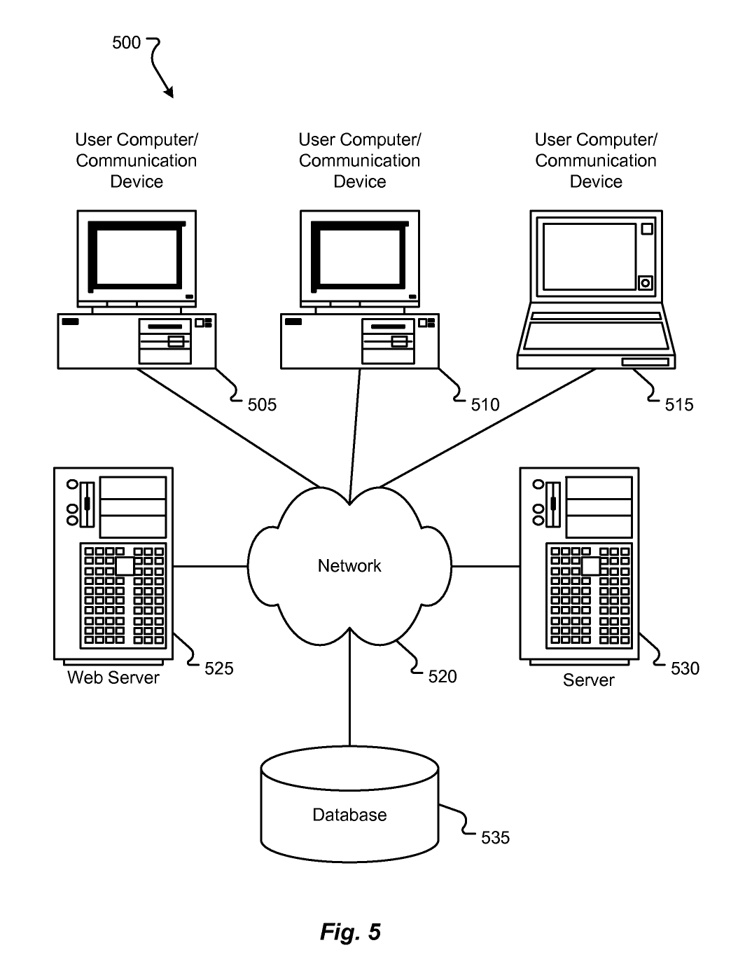

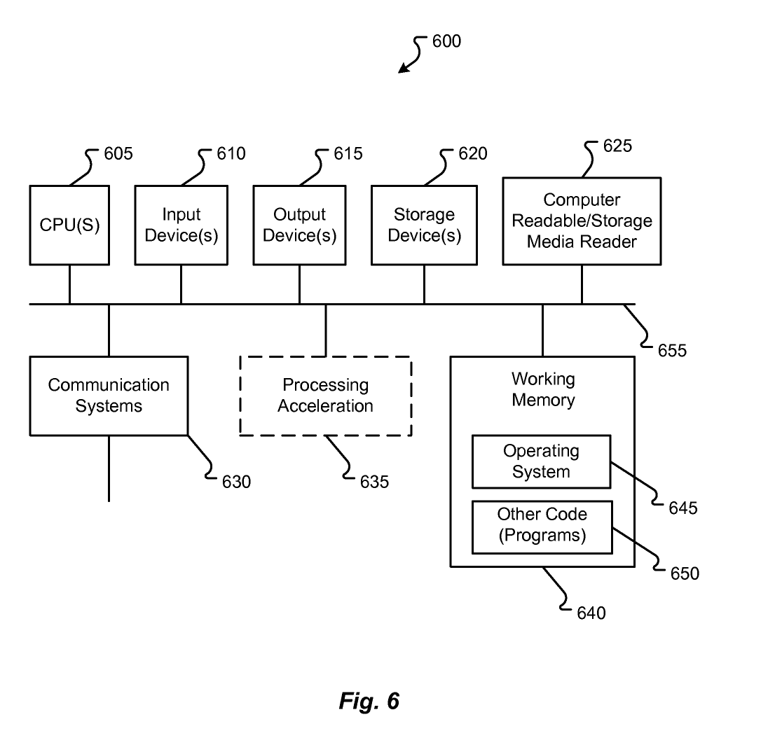

The network 112 can be any network or system operable to allow communication between the contact center 102 and the one or more social media networks 116, 118, and/or 120. The network 112 can represent any communication system, whether wired and/or wireless, using any protocol and/or format. One exemplary implementation of the network 112 is the Internet. The network 112 provides communication capability for the contact center 102 to communicate with sites (i.e., web-servers or server clusters via http formatted request and response protocols) corresponding to the one or more social media networks 116, 118, and/or 120. However, the network 112 can represent two or more networks, where each network is a different communication system using different communication protocols and/or formats and/or different hardware and software. For example, network 112 can be a wide area network, local area network, the Internet, a cellular telephone network, or some other type of communication system. The network may be as described in conjunction with FIGS. 5 and 6.

A contact center 102 can be a system owned and operated by an enterprise that can communicate with one or more persons that use social media networking sites. In some embodiments, the enterprise administering the contact center 102 may offer products and/or services to various customers. In some embodiments, the contact center 102 may be utilized to offer the products and/or services. In some embodiments, the contact center 102 may be utilized to provide customer support and related services for previously sold products and/or services. The contact center 102 can be hardware, software, or a combination of hardware and software. The contact center 102 can be executed by one or more servers or computer systems, as described in conjunction with FIGS. 5 and 6. The contact center 102 can include all systems, whether hardware or software, which allows the contact center 102 to receive, service, and respond to directed and automatically-retrieved contacts. For example the contact center 102 can include the telephone or email system, the interface to human agents, systems to allow human agents to service and respond to received contacts, and one or more systems operable to analyze and improve the function of agent interaction.

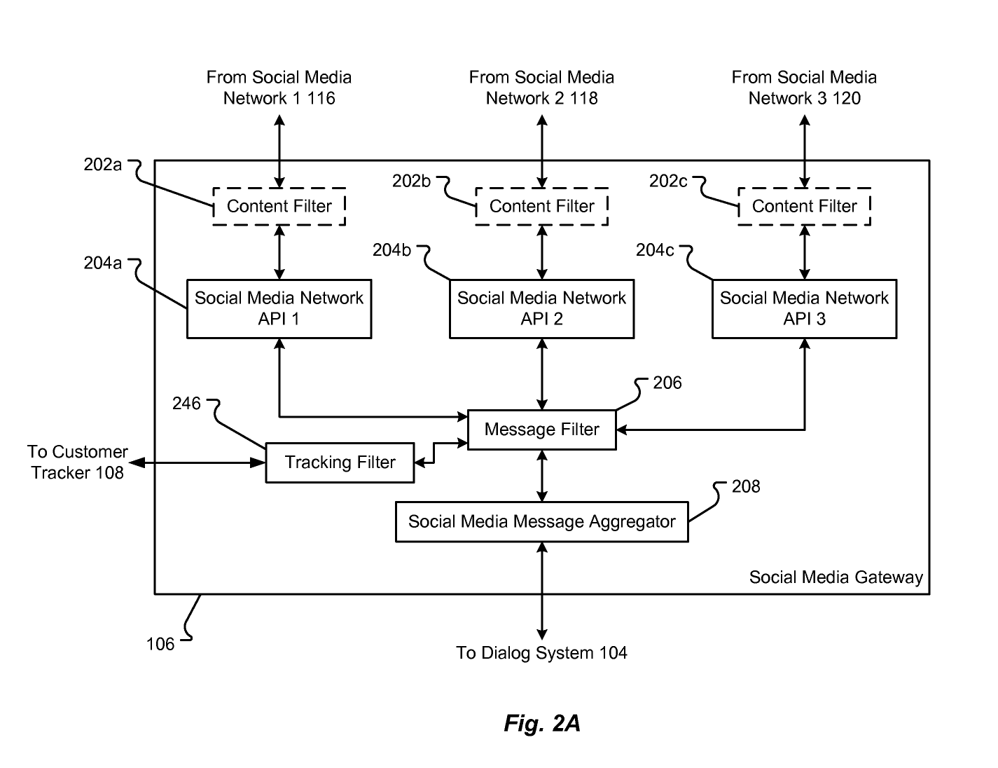

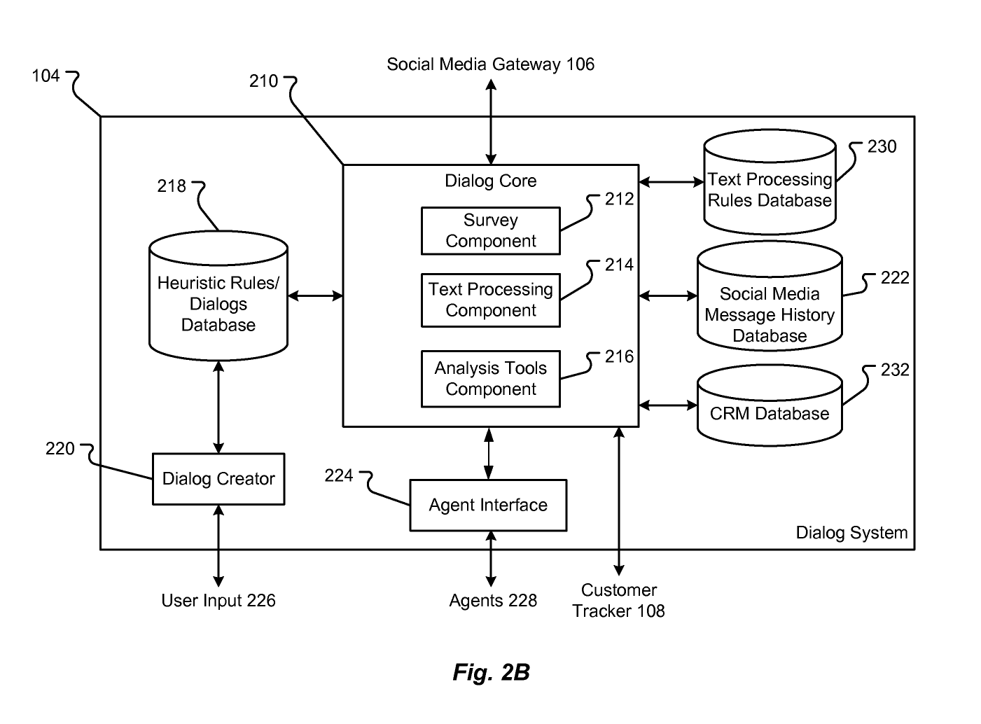

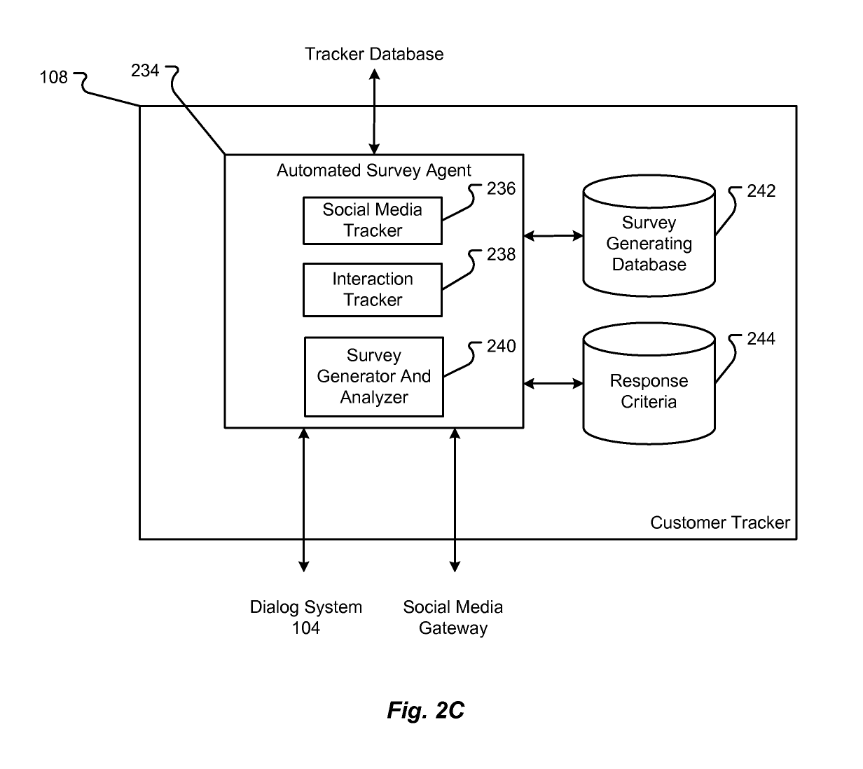

The contact center 102 may include a dialog system 104 and a social media gateway 106. While the dialog system 104 and the social media gateway 106 are shown as being a part of the contact system 102, in other embodiments, the dialog system 104 and/or the social media gateway 106 are separate systems or functions executed separately from the contact center 102 and/or executed by a third party. The dialog system 104 may process and receive messages. The social media gateway 106 can receive and translate messages from the one or more social media networks 116, 118, and/or 120. An embodiment of the dialog system 104 is described in conjunction with FIG. 2B. An embodiment of the social media gateway 106 is described in conjunction with FIG. 2A.

In some embodiments, the contact center 102 further includes a customer tracker 108 and a tracker database 110. The customer tracker 108 may include functionality for conducting automatic customer feedback surveys via the social media networks 116, 118, and/or 120. In conducting such surveys, the customer tracker 108 may retrieve data from the tracker database 110 that helps to identify information sources for the customer survey (i.e., which of the social media networks 116, 118, 120 should be monitored during the customer survey), analyze data retrieved during a customer survey, refine customer survey results, and produce automated responses thereto. An embodiment of the customer tracker 108 is described in conjunction with FIG. 2C.

The contact center 102 may also communicate with one or more communication devices 114. The communication devices 114 can represent a customer's or user's cell phone, email system, personal digital assistant, laptop computer, or other device that allows the contact center 102 to interact with the customer. The contact center 102 can modify a non-direct contact, from a social media network 116, 118, and/or 120, into a directed contact by sending a response message directly to a customer's communication device 114.

An embodiment of the social media gateway 106 is shown in FIG. 2A. The social media gateway 106 can include one or more components which may include hardware, software, or combination of hardware and software. The social media gateway 106 can be executed by a computer system such as those in conjunction with FIGS. 5 and 6. However, in other embodiments, the components described in conjunction with FIG. 2A are logic circuits or other specially-designed hardware that are embodied in a field programmable gate array (FPGA).

Herein, the social media gateway 106 can include one or more content filters 202a, 202b, and/or 202c. A content filter 202 can receive all of the messages for the contact center 102 from a social media network 116, 118, and/or 120 and eliminate or delete those messages that do not require a response or relate to a particular customer survey. For example, a message between two friends on a Facebook page, if not pertaining to a product or a service of the company operating the contact center 102, may not need a response. As such, the content filter 202 can filter out or delete that non-suitable message from the messages that are received by social media network application programming interface (API) 1 204a, social media network API 2 204b, and/or social media network API 3 204c. With the content filter 202, the social media network API 204 only needs to translate those messages that should be received by the dialog system 104. Translation typically requires the conversion of the message into a different format.

The content filter 202 is provided with one or more heuristics for filter rules from a filter database (not shown). These filter rules can be created by the external customer or internal user (e.g. agent or administrator) of the communication system 100. Thus, the user or customer of the communication system 100 can customize the filtering of messages from social media networks 116, 118, and/or 120. Further, different rules may be applied to different social media networks, as some social media networks may have different types of messages or postings than other types of social media networks.

While the content filter 202 is shown as part of the social media gateway 106, it is to be appreciated that the content filter 202 may be a part of the social media network API 204. The content filter 202 may correspond to the query terms used by the social media network API 204. The content filter 202 or query terms are an argument to the social media network API 204 call. The social media network API 204 can be an application that the social media network 116, 118, and/or 120 provides to access the site. Thus, the social media network API 204 is called and connects the social media gateway 106 to the social media network 116, 118, and/or 120. Any suitable filter criteria may be employed. Examples include social media identifier (i.e., the known social media identifier of a customer of the enterprise that operates the contact center 102), content of source, address field, destination or recipient address fields, time stamp field, subject matter field, and message body field. For example, an obvious searchable content is the name of the business enterprise running the contact center 102 and/or products or services of the enterprises.

The social media gateway 106 can include one or more social media network API 204. As shown in FIG. 2A, the social media gateway 106 may include a social media network API 204 for each social media network 116, 118, and/or 120. As such, the social media gateway 106 can interact with each social media network 116, 118, and/or 120 in the particular (often unique) format or protocol used by the social media network 116, 118, and/or 120. Further, when new social media networks are created, the social media gateway 106 can easily be expanded to interact with those social media networks by adding another social media network API 204. Where social media networks 116, 118, and/or 120 are more standardized, or use substantially similar formats or protocols, a single social media network API can be shared by multiple such social media networks 116, 118, and/or 120.

The social media network API 204 can receive messages from and send messages corresponding to the social media network 116, 118, and/or 120. The social media network API 204 can translate a message received from a social media network 116, 118, and/or 120and send the translated message to a message filter 206. The social media network API 204 can translate the received message into a standard formatted file. For example, the translated message may be represented by an extensible mark-up language (XML) file or other file having a general format. As such, each specific and particular social media network message can be translated into a standard format for use by the dialog system 104. Further, the social media network API 204 can receive a generally or standard format response message, from the dialog system 104 and translate that response into a particularly or specifically formatted response message that can be posted to the corresponding social media network 116, 118, and/or 120.

Messages to the contact center 102 are addressed to the contact center 102. For example, a customer may become a “friend” of the contact center 102 on a social media network 118, such as Facebook. The customer may then address a message to the contact center 102 on Facebook. This non-direct contact is a message that is not sent directly to the contact center 102 but to the contact center's Facebook page. In other embodiments, the contact center 102 receives messages not addressed to the contact center 102. For example, the contact center 102 can receive tweets from Twitter that are “broadcast” rather than addressed to the contact center 102. The contact center 102 may also search for message or content on the social media network 116, 118, and/or 120. Exemplary search criteria include customer name, customer profession, customer home address, customer business address, customer employer name, customer educational or professional background, customer hobby, personal or business interests, customer family profile, product name, service name, and the like. Thus, the social media gateway 106 of the contact center 102 can query, gather, or connect to a live feed of data from a social media network 116, 118, and/or 120 and then apply a filter to the indirect information.

The translated messages from the social media network API 204 can be received by a message filter 206. A message filter 206 can perform some or all of the functions of the content filter 202 and eliminate messages before being sent to the dialog system 104. However, in other embodiments, the message filter 206 eliminates information from within the messages before the trimmed messages are sent to the dialog system 104. For example, a message from a social media network 116 may have three or four interactions between two parties not associated with the contact center 102. Only one of the several postings may be pertinent to the dialog system 104. As such, the message filter 206 can eliminate or delete at least a portion of the other messages for the dialog system 104. Thus, the dialog system 104 receives a message where some of the content of the message has been deleted. The message filter 206 can retrieve heuristics or filter rules from a filter database (not shown), similar to the content filter 202. A substantial difference between the content and message filters 202 and 206 is that the content filter 202 is specific to a particular message format associated with a corresponding social media network 116, 118, and/or 120, while the message filter 206 is applied to a standardized or universal format and is therefore common to multiple social media networks 116, 118, and/or 120. One skilled in the art will understand the type of rules that may be used to filter information from messages such that only pertinent questions, facts, requests, or information is sent to the dialog system 104.

A message aggregator 208 may also be included with the social media gateway 106. A message aggregator 208 can, in contrast to the message filter 206, combine two or more messages into a packet or grouping that is sent to the dialog system 104. Therefore, the message aggregator 208 can inter-relate or combine messages based on different information within the messages. For example, two messages may be combined based on any of the message fields referenced above, such as the person that posted the message, the subject, the request or question asked, the person the message was sent to, or other information that may be pertinent to the dialog system 104. Thus, the dialog system 104 may be able to respond concurrently to two or more messages based on a grouping provided by the message aggregator 208. If the messages are aggregated or not aggregated, each message can be sent from the social media gateway 106 to the dialog system 104.

The social media gateway 106 can also send responses back to the social media networks 116, 118, and/or 120. A response from an agent in the contact center 102 can be sent to the social media gateway 106. The response may be in a general format and translated. The translated response may then be posted to the appropriate social media network 116, 118, and/or 120 by the social media gateway 106. In other embodiments, the agent may post the response directly to the social media network 116, 118, and/or 120 without sending the response to the social media gateway 106.

The social media gateway 106 can further include a tracking filter 246 which comprises filter rules sufficient to further eliminate data not relevant to a customer survey. In particular, data retrieved from one or more information sources (e.g., social media network 116, 118, and/or 120) can be filtered into data relevant to a customer survey and other data not relevant to a customer survey. For example, the tracking filter 246 may be used to eliminate data that is related to a certain product because that data contained the name of the product therein, but that does not necessarily reflect an opinion of that product (e.g., because it does not contain any content which indicates a preference for or against the product or service, but only casually mentions the product or service as part of another conversation). Data which is not useful to creating customer feedback results for a product or service may be filtered out by the tracking filter 246, thereby minimizing the amount of data that is processed by the customer tracker 108.

As can be appreciated, although the tracking filter 246 is depicted as part of the social media gateway 106, the tracking filter 246 may be optionally executed within the dialog system 104 and, in particular, executed by a survey component 212 of the dialog core 210 contained within the dialog system 104.

An embodiment of the dialog system 104 is shown in FIG. 2B. The dialog system 104 can include one or more components which may be hardware, software, or combination of hardware and software. The dialog system 104 can be executed by a computer system such as those described in conjunction with FIGS. 5 and 6. However, in other embodiments, the components described in conjunction with FIG. 2B, are logic circuits or other specially-designed hardware that are embodied in a field programmable gate array (FPGA) or application specific integrated circuit (ASIC). The components contained within the dialog system 104 can include a dialog core 210 that is communication with a message history database 222, an agent interface 224, and a heuristic rules and dialogs database 218. Further, the heuristic rules and dialogs database 218 can be in communication with a dialog creator 220.

The dialog core 210 can include one or more sub-components. For example, the dialog core 210 includes a survey component 212, a text processing component 214, and an analysis tools component 216. These components, similar to the components for the dialog system 104, can be hardware, software, or combination of hardware and software. The dialog core 210 steps through the states of a dialog data structure. A dialog is a set of inputs and associated actions that can be taken which allow for the automatic and structured response to social media requests or messages as well as the automatic and structured response to negative social media feedback. For example, if a user asks for a manual, the input of the text word “manual” can cause the dialog system 104 to send information about one or more manuals. In turn, the receiver of the response may respond, in kind, with the selection of a certain user manual. In which case, the dialog data structure may then automatically send the user to a website where the user can retrieve an electronic version of the manual. As such, the dialog data structure allows the dialog core 210 to automate the interaction between the contact center 102 and a person. This automation eliminates the need for agent involvement, in some situations, and makes the contact center 102 more efficient and more effective. Further, the automation expands the contact center's ability to answer numerous messages from the plethora of postings on the numerous social media networks 116, 118, and/or 120.

The dialog creator 220 will create a dialog data structure 300 that steps through various states for each social media message that comes into the contact center 102. The first step might be to send the social media message to the survey component 212, then to the text processing component 214, and then execute a query of a Customer Relationship Management (CRM) system and a CRM database 232 (to find out if this user has an existing order). A CRM database 232 can store information about customers or other data related to customer relations. Finally the dialog data structure might decide that the social media message should be sent to a human agent 228 for processing. The CRM database 232 may be the same or similar to the tracker database 110 in that the CRM database 232 can store information regarding customers of the contact center 102. The states or node transitions are in the dialog core 210 and make use of many different components that the dialog creator 220 combines in any way the user desires to handle the social media messages. The dialog core 210 can make use of the survey component 212, text processing component 214, or other systems. The dialog core 210 may also interface with a CRM system and/or CRM database 232, external databases, social media user information (e.g., followers, friends, post history, etc. from the social media site), or other systems.

The survey component 212 is operable to analyze incoming data from the social media gateway 106 and determine whether it is relevant to a customer survey currently being conducted. If so, the identified relevant data may be provided to the customer tracker 108. As noted above, the survey component 212 may utilize the filter rules, such as those contained in tracking filter 246 to sort the incoming data into customer-survey-relevant data and other non-relevant data. When data is identified as being relevant to a customer survey currently being conducted by the contact center 102, then the survey component 212 may forward the data to the customer tracker 108. In some embodiments, data relevant to a customer survey may only be provided to the customer tracker 108 (meaning that no other components of the dialog core 210 have to process the data). In some embodiments, data relevant to a customer survey may be sent to the customer tracker 108 and a copy thereof may also be sent to the text processing component 214.

The text processing component 214 is operable to analyze text of one or more messages from social media networks 116, 118, and/or 120. Some possible methods for text processing can include Regular Expression, Latent Semantic Indexing (LSI), text part of speech tagging, text clustering, N-Gram document analysis, etc. In addition, for possibly longer documents, (such as, blogs or emails), the text processing component 214 may execute one or more methods of document summarization. The summarization may occur if the social media message will be sent to an agent 228 of the contact center 102; the summarization can reduce the amount of information that the agent may manage. The text processing rules or models may be stored in and/or retrieved from a text processing rules database 230. The text processing rules database 230 can be a database as described in conjunction with FIGS. 5 and 6 that stores rules or models used by the text processing component 214.

The text processing component 214 can identify one or more occurrences of a particular text, such as using one or more of the message fields referenced above, in order to associate that social media message with one or more dialogs data structures in the heuristic rules and dialog database 218. For example, the text processing component can look for the word “manual,” in the social media message. If the word “manual” is found, the text processing component 214 may retrieve a dialog from the heuristic rules and dialogs database 218, which communicates with the customer about one or more owner's manuals, repair manuals, or other types of manuals. In another example, if the social media message includes the words, “buy”, “sell”, “price, “discount” or other types of words that may indicate the user or customer wishes to buy a product, the text processing component 214 can retrieve one or more dialogs from the heuristic rules and dialogs database 218 that can assist the customer in purchasing products or services from the enterprise.

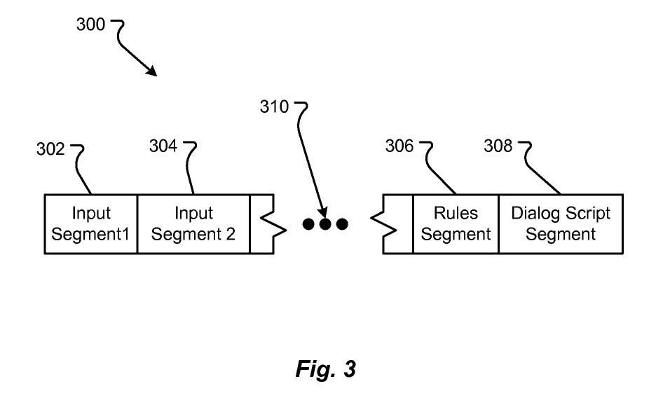

The analysis tools component 216 is operable to analyze response messages received back from an agent interface 224. In analyzing the agent's responses, the analysis tools component 216 can determine if the dialog data structures 300 (FIG. 3) originally retrieved by the text processing component 214 met the needs of the customer. The analysis tools component 216 may also be configured to determine whether a dialog data structure 300 generated in response to a poor customer feedback survey is sufficient for responding to the customer response. In the analysis, the agent may enter one or more items of information, for the analysis tools component 216, about the response and about how the response matched with the dialog data structures 300. The analysis tools component 216 can review the response and determine if it was similar to the response provided by the dialog data structure 300. Thus, the analysis tools component 216 can provide information to the dialog core 210 or the dialog creator 220 to improve the dialog data structures 300 (FIG. 3) that are included in the heuristic rules and dialogs database 218.

The message history database 222 can be any database or data storage system as described in conjunction with FIGS. 5 and 6. Thus, the message history database 222 can store data in data fields, objects, or other data structures to allow other systems to retrieve that information at a later time. The message history database 222 can store previous messages or information about previous messages. Thus, for example, if the survey component 212 is analyzing several messages over a period of time, the survey component 212 can retrieve information about previous messages associated with the current survey from the message history database 222. As such, the survey component 212 can better identify relevant survey data from the social media networks 116, 118, and/or 120. The data stored by the message history database 222 can include the entire message or only a portion of the message, and in some circumstances, include metadata about the message(s).

The heuristic rules and dialogs database 218 can be any type of database or data storage system as described in conjunction with FIGS. 5 and 6. The heuristic rules and dialogs database 218 can store information and data fields, data objects, and/or any other data structures. An example of information stored within the heuristic rules and dialogs database 218 is described in conjunction with FIG. 3. The heuristic rules and dialogs database 218 stores rules and dialogs that automate responses to received social media messages. The dialogs control the interaction between the dialog core 210 and the social media network 116, 118, and/or 120. The dialogs or heuristic rules can be created by a dialog creator 220. Thus, the dialog creator 220 can interface with the user input 226 to receive information about dialogs. The user input 226 is then used to form the states and responses for a dialog.

An agent interface 224 is a communication system operable to send action items to contact center agents, in the contact center 102. An agent can be a person or other system that is operable to respond to certain questions or requests from a customer. For example, the agent can be a person that has specialized expertise in a topic area, such as technical support. The agent interface 224 can format the social message into an action item and forward that message to one or more agents 228. The agent interface 224 can also receive response(s) back from the agents 228. The information provided by the agent may be used by the dialog core 210 to complete a response to the social media message. For example, the information may classify the social media message (e.g., sales, service, etc.). In other embodiments, the response is a complete response to the social media message that can be posted to the social media network 116, 118, and/or 120.

An embodiment of the customer tracker 108 is shown in FIG. 2C. The customer tracker 108 can include one or more components which may be hardware, software, or combination of hardware and software. The customer tracker 108 can be executed by a computer system such as those described in conjunction with FIGS. 5 and 6. However, in other embodiments, the components described in conjunction with FIG. 2C, are logic circuits or other specially-designed hardware that are embodied in a field programmable gate array (FPGA) or application specific integrated circuit (ASIC). The components contained within the customer tracker 108 can include an automated survey agent 234, a survey generating database 242, and a response criteria database 244.

The automated survey agent 234 may include a number of sub-components for administering automated customer feedback surveys and generating results in connection therewith. For instance, the automated survey agent 234 may include a social media tracker 236, an interaction tracker 238, and a survey generator and analyzer 240.

The social media tracker 236 may comprise the functionality to identify potential sources of customer feedback. In particular, the social media tracker 236 can analyze parameters associated with a desired customer survey and, based on those parameters, analyze all publicly-available sources of information to determine which of those sources are likely to have data relevant to the desired customer survey. In some embodiments, a publicly-available source of information may correspond to one or more web servers associated with the social media networks 116, 118, and/or 120. In some embodiments, the publicly-available sources of information may not be totally accessible to all members of the public. Rather, access to such sources of information may be protected by one or more of a password, user name, and other related permissions. Assuming that the enterprise operating the contact center 102 has sufficient data to access an otherwise non-public conversation at one of the social media networks 116, 118, and/or 120, the source of that data may be considered publicly-accessible. In some embodiments, the social media tracker 236 is able to retrieve data necessary for accessing a publicly-accessible information source from the tracker database 110. For example, if a publicly-accessible information source is identified as a particular social networking website, and more particularly a user of that website, then the social media tracker 236 may be configured to retrieve the user's identifier for that website and monitor posts made to that website by that user (e.g., via identifying posts made under the user's identifier and retrieving the same).

The interaction tracker 238 may be configured to determine when a survey should begin. In other words, the interaction tracker 238 may be configured to monitor the social media history database 222 and any other agent-customer interaction within the contact center 102 to determine whether a survey-initiating trigger has occurred. When such an event has occurred, the interaction tracker 238 is configured to invoke the social media tracker 236 for a predetermined amount following the detection of the survey-initiating trigger. In some embodiments, the predetermined amount of time for which the automated survey is conducted may vary depending upon the type of survey-initiating trigger detected, the number of publicly-available information sources identified, and the number of customers being monitored for feedback. All of these determinations may be made based upon data stored in the survey generating database 242. In particular, the survey generating database 242 may comprise rules and metrics used for generating automated customer surveys including algorithms for determining how long a customer survey should be conducted and what constitutes a possible source of information.

The survey generator and analyzer 240 may be configured to operate in cooperation with the social media tracker 236. In particular, data gathered by the social media tracker 236 may be analyzed, in real-time (e.g., as it is received by the social media tracker 236) by the survey generator and analyzer 240. Based on the data analysis performed by the survey generator and analyzer 240, real-time customer survey results can be obtained and reported, as needed. Moreover, the survey generator and analyzer 240 may be configured to determine, in real-time, whether the survey results are meeting a particular threshold. If the survey generator and analyzer 240 determines that customer survey results are falling below the predefined threshold, then the survey generator and analyzer 240 may construct a proposed response in the form of a dialog data structure 300. The rules for determining whether survey results are adequate and determining the form of the response dialog data structure 300 may be maintained in the response criteria database 244.

An embodiment of a dialog data structure 300 is shown in FIG. 3. The dialog data structure 300 can be stored in several different forms of databases, such as relational databases, flat files, object-oriented databases, etc. Thus, while the term “data field” or “segment” is used, the data may be stored in an object, an attribute of an object, or some other form of data structure. Further, the dialog data structure 300 can be stored, retrieved, sent, or received during the processing of dialogs by the dialog core 210, the dialog creator 220, or the survey generator and analyzer 240. The dialog data structure 300 stores one or more items of information in one or more data fields. The numeric identifiers (e.g. 302, 304, etc.) shown in FIG. 3 can identify, in one or more fields or segments, either the data field or segment or the data stored in the data field or segment.

The dialog data structure 300 can include one or more input segments, such as, input segment 1 302 and input segment 2 304, a rules segment 306, and/or a dialog script segment 308. Input segments 302 and 304 each include one or more fields comprising the one or more inputs that may be required to associate a social media message with the dialog data structure 300 or inputs that may be required to associate customer survey results with the dialog data structure 300. The inputs segments 302 and 304 may include a customer identity, a respective customer type, a text word, a phrase, a product name, a service description, a customer's social media identifier, or other information that indicates that the dialog data structure 300 is associated with the social media messages or customer survey results. While there are only two input segments 1 302 and 2 304 shown in FIG. 3, there may be more or fewer input segments associated with the dialog data structure 300, as indicated by ellipses 310.

The rules segment 306 can include one or more heuristic rules that either help with the association of the respective dialog data structure 300 with the social media message or control the interaction between the dialog core 210 and the social media customer. For example, the rule 306 can state that the dialog data structure 300 applies only if the social media message includes input segment 1 302 but not input segment 2 304. One skilled in the art will be able to identify other types of rules that may govern the association of the dialog data structure 300 with the social media message. In other embodiments, the rules segment 306 states that if the social media message includes inputs 1 302 and/or 2 304, then the dialog core 210 or automated survey agent 234 should respond with a certain type of action.

Generally, a dialog script segment 308 includes a script of actions or responses that direct one or more other components, such as the dialog core 210 (FIG. 2B) or the automated survey agent 234 (FIG. 2C), to conduct the actions or send the responses. The dialog script segment 308 can include the one or more responses required by the dialog core 210 or automated survey agent 234. If the dialog script segment 308 applies (that is, if the social media message is requesting a certain type of information), the dialog script segment 308 may include the one or more responses that the dialog core 210 or automated survey agent 234 should communicate to respond to that social media message, include in survey results, or the like. The dialog script segment 308 can also include a response and a pointer to another dialog script segment 308 or another dialog data structure 300. Further, the dialog script segment 308 may have one or more actions that may be taken by another component after a secondary response is received by a customer. Thus, the dialog script segment 308 can allow an interaction to continue with a social media user over a period of time and several interactions between the user and the contact center 102.

It should be noted that the dialog script segment 308 can reference one or more other dialog data structures 300. Thus, the dialog script segment 308 can direct the dialog core 210 or automated survey agent 234 to reference at least one other dialog data structure 300 to further act on the social media message or update customer survey results. Further, the social media message can be subject of two or more dialog script segments 308, and direct the dialog core 210 to complete two dialog script segments on the social media message. Also, dialog script segments 308 may not be associated with a response but direct the dialog core 210 or automated survey agent 234 to complete other actions, such as populating databases or gathering information.

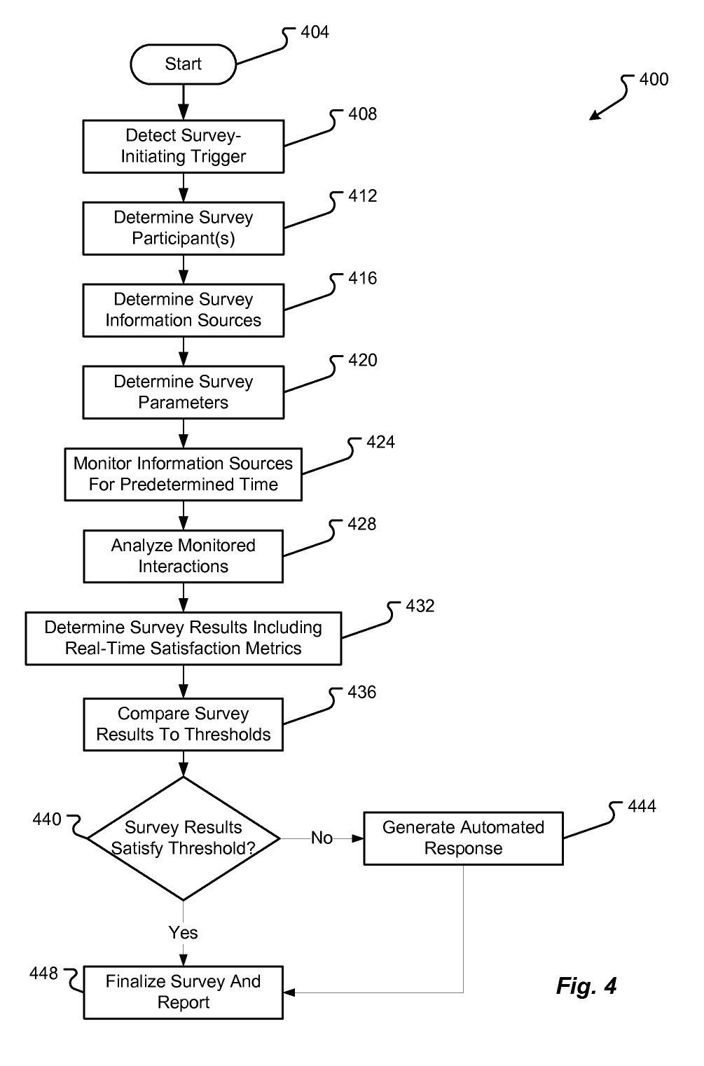

Referring now to FIG. 4, an exemplary method 400 of conducting an automated customer survey will be described. The method 400 begins (step 404) and continues when a survey-initiating trigger is detected by the interaction tracker 238 (step 408). The types of events which may constitute a survey-initiating trigger include, without limitation, receiving a contact at the contact center 102, determining that a contact has been serviced by the contact center 102, determining that a contact related to one or more of a product and service offered by an enterprise associated with the contact center 102 has been received or serviced by the contact center 102, determining that a product has been sold to a particular customer, determining that a service has been rendered for a particular customer, determining that a product launch has occurred, determining that a new service has been offered or completed, determining that a product has been released to a finite set of customers, determining that a service has been rendered for a finite set of customers, determining that a customer complaint has been received regarding a product or service, anticipating one or more of the above events, and combinations thereof.

Once a survey-initiating trigger has been detected, the method 400 continues with the automated survey agent 234 identifying one or more survey participants (step 412). This determination may be made based on the triggering event or parameters contained in the triggering event. For example, if the triggering event related to a particular customer having a contact with the contact center 102, then the survey participant may solely comprise the particular customer. As another example, if the triggering event related to a particular service, then the survey participants may include any possible customers that known to have received the service. This information may be obtained from the tracker database 110, survey generating database 242, and/or CRM database 232.

The method 400 also involves determining survey information sources (step 416). This step may be similar or related to step 412 in that the identification of information sources may depend upon the triggering event or parameters contained in the triggering event. In some embodiments, an information source may be identified based on its association with a user that received a product or service. In other words, if a particular customer receives a product or service from an enterprise and that customer's social media identifier is known to the enterprise by virtue of it being stored in one or more of the CRM database 232 and tracker database 110, then the social media network for which the customer's social media identifier is used may be identified as an information source. Other rules which may be used to identify information sources include location information (e.g., a potential information source has a known logical or physical proximity to a product or service offered).

The method 400 continues by determining survey parameters, which may include an amount of time for which a survey will be conducted as well as filter rules which will be utilized in the tracking filter 246 (step 420). Thereafter, the identified information sources are monitored by the social media tracker 236 for the predetermined amount of time (step 424).

The monitored interactions received from the various information sources (e.g., the data feeds obtained from the social media networks 116, 118, and/or 120) may then be analyzed by the survey generator and analyzer 240 (step 428). In some embodiments, the analysis is performed in real-time, meaning that as data is received at the contact center 102 and that data passes through the tracking filter 246, the survey generator and analyzer 240 is configured to analyze the data. In some embodiments, the analysis is performed after some or all of the data has been retrieved from the identified information sources. In any event, it is generally preferable to perform the analysis only on data which passes through the tracking filter 246, so as to minimize, to the extent possible, the amount of analysis performed by the survey generator and analyzer 240.

Based on the analysis of the monitored interactions, the survey generator and analyzer 240 determines survey results, which may include real-time satisfaction metrics if the analysis is performed in real-time (step 432). The content of the survey results can be quantified based on predetermined metrics or rules and compared to a predetermined threshold (step 436). For instance, a customer response determined to be relevant to the customer survey (i.e., by virtue of passing the content filter 202a, 202b, 202c, the message filter 206, and tracking filter 246) may be classified as either a positive or negative response. The survey results may comprise a percentage metric of the number of positive responses as compared to total responses and that percentage metric (e.g., 75% positive responses) can be compared to a predetermined percentage metric (e.g., 80% positive responses required). Other ways of quantifying the survey results for comparison to a predetermined threshold will become readily apparent to those skilled in the art. For instance, the positive survey results may be totaled and compared to a scalar number of required positive survey results. Alternatively, or in addition, negative survey results may be compared to a predetermined threshold. Alternatively, or in addition, a degree of customer satisfaction may be assigned to a response based on the number of positive and/or negative adjectives used in the response, the relationship between positive and/or negative adjectives used with respect to a product or service name or synonym (i.e., temporal proximity as determined by the number of words separating two items), etc. and the degree of customer satisfaction may be used in the comparison step.

The results of the comparison are then analyzed by the survey generator and analyzer 240 and it is determined whether or not the survey results satisfy the thresholds set forth by the enterprise (step 440). If the survey results do not satisfy the threshold, then the survey generator and analyzer 240 may automatically generate a response for posting on the various information sources (step 444). In particular, the survey generator and analyzer 240 may utilize one or more data structures 300 contained in the survey generating database 242 to generate an automated response message that can be transmitted back to the information source from which the response was obtained. The response message can then be posted for public viewing (at least publicly accessible for persons with permissions, if required) on that same information source.

Thereafter, or in the event that the survey results satisfied the predetermined threshold, an actual survey report is finalize and transmitted to one or more interested parties (step 448). For example, the survey report may be generated with a data structure 300 and transmitted to a product manager (if the survey related to a product) or a service manager (if the survey related to a survey).

The method 400 may then either end or return back to step 404.

FIG. 5 illustrates a block diagram of a system 500 that may function as servers, computers, or other systems provided herein. The system 500 includes one or more user computers 505, 510, and 515. The user computers 505, 510, and 515 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIXTM or UNIX-like operating systems. These user computers 505, 510, 515 may also have any of a variety of applications, including for example, database client and/or server applications, and web browser applications. Alternatively, the user computers 505, 510, and 515 may be any other electronic device, such as a thin-client computer, Internet-enabled mobile telephone, and/or personal digital assistant, capable of communicating via a network 520 and/or displaying and navigating web pages or other types of electronic documents. Although the exemplary system 500 is shown with three user computers, any number of user computers may be supported.

System 500 further includes a network 520. The network 520 may can be any type of network familiar to those skilled in the art that can support data communications using any of a variety of commercially-available protocols, including without limitation SIP, TCP/IP, SNA, IPX, AppleTalk, and the like. Merely by way of example, the network 520 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 502.11 suite of protocols, the Bluetooth™ protocol known in the art, and/or any other wireless protocol); and/or any combination of these and/or other networks. The network 520 may be the same or similar to network 105.

The system may also include one or more server computers 525, 530. One server may be a web server 525, which may be used to process requests for web pages or other electronic documents from user computers 505, 510, and 520. The web server can be running an operating system including any of those discussed above, as well as any commercially-available server operating systems. The web server 525 can also run a variety of server applications, including SIP servers, HTTP servers, FTP servers, CGI servers, database servers, Java servers, and the like. In some instances, the web server 525 may publish operations available operations as one or more web services.

The system 500 may also include one or more file and or/application servers 530, which can, in addition to an operating system, include one or more applications accessible by a client running on one or more of the user computers 505, 510, 515. The server(s) 530 may be one or more general purpose computers capable of executing programs or scripts in response to the user computers 505, 510 and 515. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 530 may also include database servers, including without limitation those commercially available from Oracle, Microsoft, Sybase™, IBM™ and the like, which can process requests from database clients running on a user computer 505.

The web pages created by the web application server 530 may be forwarded to a user computer 505 via a web server 525. Similarly, the web server 525 may be able to receive web page requests, web services invocations, and/or input data from a user computer 705 and can forward the web page requests and/or input data to the web application server 730. In further embodiments, the server 530 may function as a file server. Although for ease of description, FIG. 5 illustrates a separate web server 525 and file/application server 530, those skilled in the art will recognize that the functions described with respect to servers 525, 530 may be performed by a single server and/or a plurality of specialized servers, depending on implementation-specific needs and parameters. The computer systems 505, 510, and 515, file server 525 and/or application server 530 may function as the system, devices, or components described in FIGS. 1-3.

The system 500 may also include a database 535. The database 535 may reside in a variety of locations. By way of example, database 535 may reside on a storage medium local to (and/or resident in) one or more of the computers 505, 510, 515, 525, 530. Alternatively, it may be remote from any or all of the computers 505, 510, 515, 525, 530, and in communication (e.g., via the network 520) with one or more of these. In a particular set of embodiments, the database 535 may reside in a storage-area network (“SAN”) familiar to those skilled in the art. Similarly, any necessary files for performing the functions attributed to the computers 505, 510, 515, 525, 530 may be stored locally on the respective computer and/or remotely, as appropriate. In one set of embodiments, the database 535 may be a relational database, such as Oracle 10i™, that is adapted to store, update, and retrieve data in response to SQL-formatted commands.

FIG. 6 illustrates one embodiment of a computer system 600 upon which the servers, computers, or other systems or components described herein may be deployed or executed. The computer system 600 is shown comprising hardware elements that may be electrically coupled via a bus 655. The hardware elements may include one or more central processing units (CPUs) 605; one or more input devices 610 (e.g., a mouse, a keyboard, etc.); and one or more output devices 615 (e.g., a display device, a printer, etc.). The computer system 600 may also include one or more storage devices 620. By way of example, storage device(s) 620 may be disk drives, optical storage devices, solid-state storage devices such as a random access memory (“RAM”) and/or a read-only memory (“ROM”), which can be programmable, flash-updateable and/or the like.

The computer system 600 may additionally include a computer-readable storage media reader 625; a communications system 630 (e.g., a modem, a network card (wireless or wired), an infra-red communication device, etc.); and working memory 640, which may include RAM and ROM devices as described above. In some embodiments, the computer system 600 may also include a processing acceleration unit 635, which can include a DSP, a special-purpose processor, and/or the like.

The computer-readable storage media reader 625 can further be connected to a computer-readable storage medium, together (and, optionally, in combination with storage device(s) 620) comprehensively representing remote, local, fixed, and/or removable storage devices plus storage media for temporarily and/or more permanently containing computer-readable information. The communications system 630 may permit data to be exchanged with the network 620 and/or any other computer described above with respect to the system 600. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 600 may also comprise software elements, shown as being currently located within a working memory 640, including an operating system 645 and/or other code 650, such as program code implementing the application server 530. It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method, comprising:
detecting a survey-initiating trigger;
based on the detecting step, identifying one or more publicly-available information sources;
monitoring the identified one or more publicly-available information sources for a predetermined amount of time after the detection of the survey-initiating trigger;
retrieving data from the one or more publicly-available information sources for the predetermined amount of time; and
generating survey results based on the retrieved data.

2. The method of claim 1, wherein the survey-initiating trigger is related to one of a product and service offered by an enterprise, the method further comprising:
creating a filter rule, wherein the filter rule comprises information sufficient to separate data retrieved from the one or more publicly-available information sources into data relevant to the one of a product and service and other non-relevant data;
applying the filter rule to the data retrieved during the predetermined amount of time;
utilizing the data relevant to the one of a product and service to generate the survey results.

3. The method of claim 2, wherein the applying step is performed as the data is retrieved from the one or more publicly-available information sources and wherein the retrieving step is performed as the data becomes publicly-accessible on the one or more publicly-available information sources thereby enabling the generation of real-time survey results.

4. The method of claim 2, wherein the one or more publicly-available information sources comprise one or more social media channels and wherein the retrieving step comprises transmitting a request to the one or more publicly-available information sources asking for the data.

5. The method of claim 4, wherein the request is an http formatted request and is transmitted over the Internet.

6. The method of claim 2, wherein identifying the one or more publicly-available information sources comprises determining a location related to the one of a product and service and identifying a publicly-available information source in proximity to the determined location.

7. The method of claim 2, wherein identifying the one or more publicly-available information sources comprises identifying one or more customers that received the one of a product and service and determining a social media identification for the identified one or more customers, the method further comprising:
incorporating the social media identification into the filter rule.

8. The method of claim 7, wherein the one or more customers received a product and related service, wherein the filter rule comprises information sufficient to separate data retrieved from the one or more publicly-available information sources into product-relevant data and service-relevant data.

9. The method of claim 8, wherein the product-relevant data is used to generate product survey result, and wherein the service-relevant data is used to generate service survey results which are different from the product survey results.

10. The method of claim 1, further comprising:
comparing the survey results to a customer satisfaction threshold;
determining that the survey results are below the customer satisfaction threshold;
generating an automated response based on determining that the survey results are below the customer satisfaction threshold; and
transmitting the automated response back to the one or more publicly-available information sources for public display.

11. A computer readable medium having stored thereon instructions that cause a computing system to execute a method for conducting an automated customer survey, the instructions comprising:
instructions configured to detect a survey-initiating trigger;
instructions configured to identify one or more publicly-available information sources;
instructions configured to monitor the identified one or more publicly-available information sources for a predetermined amount of time after the detection of the survey-initiating trigger;
instructions configured to retrieve data from the one or more publicly-available information sources for the predetermined amount of time; and
instructions configured to generate survey results based on the retrieved data.

12. The method of claim 11, wherein the survey-initiating trigger is related to one of a product and service offered by an enterprise, the instructions further comprising:
a filter rule, wherein the filter rule comprises information sufficient to separate data retrieved from the one or more publicly-available information sources into data relevant to the one of a product and service and other non-relevant data;
instructions configured to apply the filter rule to the data retrieved during the predetermined amount of time;
instructions configured to utilize the data relevant to the one of a product and service to generate the survey results.

13. The method of claim 12, wherein the one or more publicly-available information sources comprise one or more social media channels and wherein the retrieving step comprises transmitting a request to the one or more publicly-available information sources asking for the data.

14. The method of claim 12, wherein identifying the one or more publicly-available information sources comprises identifying one or more customers that received the one of a product and service and determining a social media identification for the identified one or more customers, and wherein the social media identification is incorporated into the filter rule.

15. The method of claim 11, wherein the instructions further comprise:
instructions configured to compare the survey results to a customer satisfaction threshold;
instructions configured to determine that the survey results are below the customer satisfaction threshold;
instructions configured to generate an automated response based on determining that the survey results are below the customer satisfaction threshold; and
instructions configured to transmit the automated response back to the one or more publicly-available information sources for public display.

16. A communication system comprising:
a social media gateway; and
a customer tracker configured to detect a survey-initiating trigger, identify one or more publicly-available information sources and, in response thereto, invoke the social media gateway to monitor the identified one or more publicly-available information sources for a predetermined amount of time after the detection of the survey-initiating trigger and retrieve data therefrom that is used by the customer tracker to generate survey results.

17. The communication system as defined in claim 16, wherein the social media gateway comprises a tracking filter which contains one or more filtering rules containing information sufficient to separate data retrieved from the one or more publicly-available information sources into data relevant to a product or service and non-relevant data and wherein only data relevant to a product or service is provided to the customer tracker.

18. The communication system as defined in claim 17, wherein the customer tracker comprises an interaction tracker configured to utilize the data relevant to a product or service to track customer feedback regarding the product or service.

19. The communication system as defined in claim 18, wherein the customer tracker further comprises a survey generator configured to analyze the customer feedback in real-time and generate real-time survey results for the product or service.

20. The communication system as defined in claim 19, wherein the customer tracker further comprises the ability to generate automated responses when the customer feedback falls below a predefined feedback threshold and wherein the customer tracker comprises response criteria which is used to construct the automated responses.
